(19) United States
(12) Patent Application Publication
(10) Pub. No.: US 2006/0209684 A1
(43) Pub. Date: Sep. 21, 2006

(54) Data rate controller, and method of control thereof

(75) Inventor: Jing-Jo Bei, Taipei (TW)

Correspondence Address: BACON & THOMAS, PLLC, 625 SLATERS LANE, FOURTH FLOOR, ALEXANDRIA, VA, 22314, US

(73) Assignee: VIA Technologies, Inc., Taipei (TW)

(21) Appl. No.: 11/082,861

(22) Filed: Mar. 18, 2005

(51) Int. Cl. H04J 3/14; H04J 1/16; H04L 1/00; H04L 12/26; H04J 3/16; H04L 12/413; H04J 3/22

(52) U.S. Cl. 370/229; 370/468

(57) ABSTRACT

A data rate controller and a method of control thereof. The invention presents a data rate controller to control data transmission between a host and a function device via a buffer by providing an interrupt device to provide feedback of a buffer status of the buffer to the host to control data rate. The invention prevents buffer under run and overrun in isochronous transfers due to clock mismatches. The data rate controller includes an interrupt device, and an isochronous device that consists of a buffer and a buffer monitor.

### BACKGROUND OF THE INVENTION

1. Field of the Invention

The invention relates in general to a data rate controller and method of control thereof, and more particularly to a data rate controller for isochronous transfers and method of control thereof.

2. Description of the Related Art

For an electronic device that depends on isochronous transfer (hereinafter “isochronous electronic apparatus”), the rate of data transmission has to be precisely controlled. FIG. 1 (PRIOR ART) shows illustration of a conventional isochronous electronic apparatus 100. The isochronous electronic apparatus 100, such as an audio or telephony device, typically includes a function device 140 and an isochronous device 110 having at least a buffer 112. Operatively, a host 90, being the data source, is to output data packets to the isochronous electronic apparatus 100, and the isochronous endpoint 110 then acts as a data sink in receiving the data packets. Typically, the data transmission is first initiated by a driver of the host 90 (not shown) to send the data packets generated from the host 90 to the isochronous device 110 at a host clock rate CLK0. Originating from host 90, the data packets are first stored at the buffer 112, and the data packets are in turn sent from the buffer 112 to the function device 140 at an endpoint logic clock rate CLK1. Upon receiving the data packets, function device 140 responds by performing a function or capability.

To better illustrate, suppose that host 90 is a personal computer, the isochronous electronic apparatus 100 is a USB electronic device, and the function device 140 is a USB sound card, then audio data packets are to be output from the personal computer to the sound card via buffer 112 of the isochronous device 110, and the sound card responds to the received audio data packets by triggering an audio amplifier to playback audio. However, since data is being output from the personal computer continuously, a clock mismatch between the host clock rate CLK0 and the endpoint logic clock rate CLK1 would undesirably cause buffer over-run or under-run.

Accordingly, for applications that rely critically on isochronous transfer, such as in the case of audio transmissions, clock mismatches seriously affects the integrity of the data as clock mismatch will often result in audio glitches such as loud “pops” or moments of silences.

### SUMMARY OF THE INVENTION

It is therefore an object of the invention to improve the aforementioned conventional problems in isochronous transfers due to clock mismatches.

The invention achieves the above-identified object by providing a data rate controller, for controlling data transmission between a host and a function device. The host outputs a set of data packets to the data rate controller at a data rate. The data rate controller includes an interrupt device, and an isochronous device that consists of a buffer and a buffer monitor. The buffer temporarily stores the set of data packets outputted from the host, for outputting the set of data packets to the function device. The buffer monitor records a data count and generates a buffer status while the set of data packets is being output from the host. The interrupt device outputs the buffer status received from the buffer monitor, for feeding back the buffer status to adjust the data rate when being polled by the host.

The invention achieves the above object by providing a method of controlling data transmission from a host to a function device via a buffer. The method includes: outputting a set of data packets from the host to the buffer at a host clock rate (i.e. data transmission rate); then, outputting the set of data packets from the buffer to the function device; next, monitoring a data count of the buffer; generating a buffer status in response to the data count, where the buffer status is at a high level or a low level; then, polling to receive the buffer status; and, adjusting the host clock rate according to the buffer status.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows illustration of a conventional isochronous electronic apparatus.

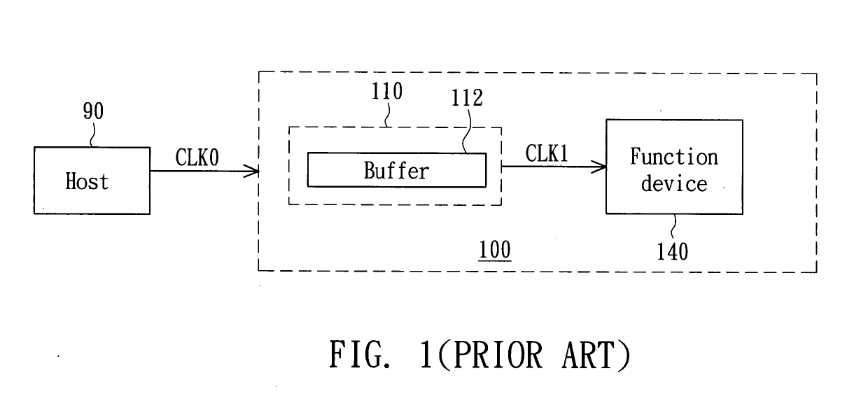

FIG. 2 shows an isochronous electronic apparatus 20 according to a preferred embodiment of the invention.

FIG. 3 shows an isochronous electronic apparatus 40 having multiple isochronous devices according to a preferred embodiment of the invention.

FIG. 4 shows a flow chart of a method of controlling data transmission from a host to a function device via a buffer according to a preferred embodiment of the invention.

FIG. 5 is a flowchart according to another preferred embodiment of the method of the invention.

FIG. 6 illustrates a flowchart of step S530 shown in FIG. 5.

### DETAILED DESCRIPTION OF THE INVENTION

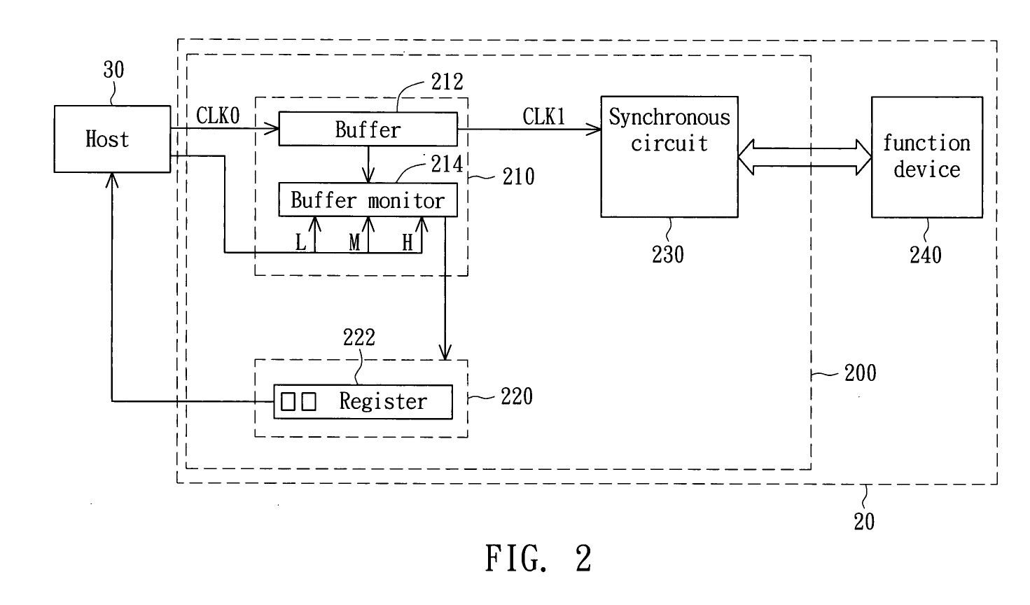

FIG. 2 shows an isochronous electronic apparatus 20 according to a preferred embodiment of the invention. The isochronous electronic apparatus 20, including a data rate controller 200 and a function device 240, is used for receiving a set of data packets from a host 30 external to the isochronous electronic apparatus 20. The set of data packets are being output from host 30 at a host clock rate CLK0, i.e. data transmission rate. The isochronous electronic apparatus 20 includes two endpoints: an isochronous device 210, and an interrupt device 220.

Isochronous device 210 includes a buffer 212 and a buffer monitor 214. After receiving the set of data packets from host 30, buffer 212 temporarily stores the set of data packets, for later outputting the set of data packets to function device 240. Logically, function device 240 then, receives the set of data packets outputted from the buffer 212.

Coupling to buffer 212, the buffer monitor 214 records a data count of the buffer 212 while the set of data packets is being output from host 30 to buffer 212 and from buffer 212 to function device 240. The buffer monitor 214 records the data count present in buffer 212 in real time. Preferably, buffer 212 is a first-in-first-out buffer. In addition to recording the data count, buffer monitor 214 also generates a buffer status according to the data count for output. The buffer status gives status information of the buffer as whether being full or empty.

The other endpoint of the data rate controller 200, being the interrupt device 220, receives the buffer status from buffer monitor 214, and outputting the buffer status, for providing a feeding back to host 30. Host 30 in turn receives the buffer status by an interrupt issued by the interrupt device 220 or by polling the interrupt device 220, thereby adjusting the host clock rate in response to the buffer status. The set of data packets usually consists a number of subframes; thus, according to the subframes, host 30 can determine the polling period based on an interval in which a certain number of subframes have been transmitted. For instance, in an isochronous USB device application, the buffer status can be polled from the interrupt device 220 by the host 30 every time (4 ms) buffer 212 has received 32 subframes.

Before the set of data packets is being sent to the isochronous electronic apparatus 20, host 30 sets a low threshold count L and a high threshold count H based on a buffer size of the buffer 212 and the host clock rate CLK0. The low and high threshold count L and H are important in that they are being used by buffer monitor 214 as a reference for setting the buffer status. Preferably, the buffer status includes a bit set, having a high bit, and a low bit. Hence, buffer monitor 214 asserts the high bit if the data count is higher than or equal to the high threshold count H, and asserts the low bit when the data count is lower than or equal to the low threshold count L. With such a scheme, host 30 can readily have knowledge of the host clock rate relative to the capacity of buffer 212, and therefore acts to adjust host clock rate CLK0 to prevent buffer 212 overrun or under-run.

Furthermore, in the preferred embodiment of the invention, the buffer status is preferably updated in response to a start-of-frame (SOF) signal. That is, the host 30 looks for a pulse indicative of the start-of-frame in the data packets. With reference to a SOF signal, the buffer monitor 214 compares the data count with the high threshold count H and the low threshold count L. When the data count is higher than or equal to the high threshold count H, the high bit is asserted; when the data count is lower than or equal to the low threshold count L, the low bit is asserted, thereby updating the buffer status. Also, the interrupt device 220 can include a register 222, such that the interrupt device 220 latches the high bit and the low bit of the buffer status in the register 222 every time the buffer status is updated.

To successfully control the host clock rate between the host 30 and the isochronous electronic apparatus 20, the host 30, upon receiving the buffer status by interrupt transfer, decreases the host clock rate CLK0 if the high bit of the buffer status is asserted, and increases the host clock rate CLK0 if the low bit of the buffer status is asserted.

To better illustrate the effects of the preferred embodiment of the invention, the isochronous electronic apparatus 20 is illustrated in an example USB device application. It is supposed that a personal computer (PC), acting as host 30, runs at a host clock rate CLK0 of 768 bytes/subframe, and buffer 212 is output the sets of data packets (8 channel audio) to the function device 240, being a USB sound card, at an endpoint logic clock rate CLK1 of 192 kb/s.

Before the PC outputs the set of data packets to the USB device (isochronous electronic apparatus 20), PC sets the low threshold count L and the high threshold H in response to a buffer size of buffer 212, and the host clock rate CLK0. For instance, for a host clock rate CLK0 of 768 bytes/subframe and a buffer size of the buffer 212 of 2304 bytes, host 20 sets a middle threshold count M to equal 1152 bytes, corresponding to the buffer size of buffer 212 and the host clock rate CLK0. Then, the low threshold count and the high threshold count are set to equal 1088 bytes and 1216 bytes, respectively.

After setting the low, middle and high threshold count L, M and H, host 20 begins outputting the set of packets to the USB device. With reference to a SOF signal, buffer monitor 214 acts to record the buffer status by comparing the data count with the low and high threshold count L and H, and asserting the high bit if the data count exceeds or is equal to the high threshold count of 1216 bytes.

Upon confirming the assertion of the high bit when the buffer status is being polled, host 30 then acts to reduce the host clock rate CLK0 so as to precisely control the rate of data transmission between the host 30 and the isochronous electronic apparatus 20, and to prevent buffer overrun. Similarly, if the data count is less than or equal to the low threshold count of 1088 bytes, the buffer monitor 214 asserts the low bit. Thus, host 30 then acts to increase the data rate, thereby effectively maintaining buffer 212 and preventing buffer under-run.

For controlling the data rate transmission, host 30 in the preferred embodiment of the invention can adjust the host clock rate CLK0 based on an integer multiple of a sample size, where the sample size refers to the size of one sample of the set of data packets. Taking the last illustration, in which the function device 240 receives the data packets (of an 8 channel audio) from the buffer at 192 kb/s, the size of a sample in a subframe equals 32 bytes. Thus, applying this scheme, if the low bit is asserted, the host clock rate of 738 bytes/subframe can be increased by, for instance, a first multiple of the sample, which equates to output the set of data packets at a faster host clock rate CLK0 of 738+32=770 bytes/sub-frame.

Likewise, the host clock rate can be decreased also by a first multiple of the sample if the buffer status indicates that the buffer exceeds the high threshold count i.e. the high bit is asserted, which equates to output the data at a lower host clock rate CLK0 of 738−32=706 bytes/sub-frame. If neither the high bit nor the low bit is asserted, however, the host clock rate is maintained and left unadjusted. Consequently, by providing a feedback of the buffer status to maintain the host clock rate CLK0, the “water mark” (data count) of the buffer 212 can remain close to the middle threshold count in reaching proper data rate control.

Additionally, the isochronous electronic apparatus 20 can further include a synchronous circuit 230, for receiving the data from the buffer 212 and outputting the data to the function device 240.

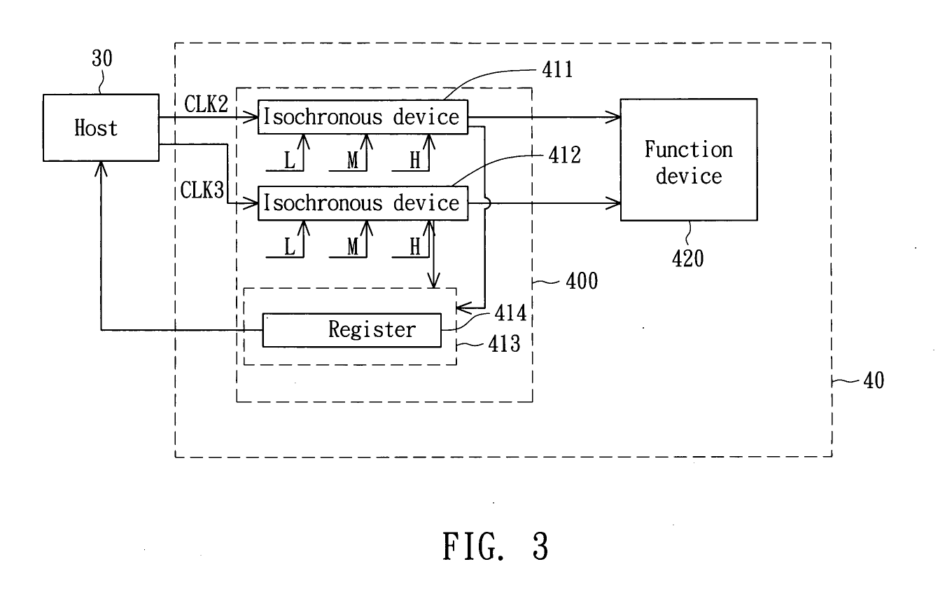

Furthermore, the isochronous electronic apparatus according to the preferred embodiment of the invention can include a plurality of isochronous devices. Referring to FIG. 3, the host 30 can further output a plurality of sets of data packets, and each of the sets of data packets corresponds to different one of the isochronous devices. It also shows an isochronous electronic apparatus 40 having multiple isochronous devices according to a preferred embodiment of the invention. The sets of data packets, such as 8 channel audio data, and SP/DIF audio data, are output correspondingly to the isochronous devices 411 and 412 at a clock rate CLK2 and CLK3 of 48 kb/s and 192 kb/s, respectively. Also, the interrupt device 413 includes a plurality of the bit sets, such that each of the bit sets corresponds to different one of the isochronous devices.

Thus, for the case when there are two isochronous devices 411 and 412, the register 414 will contain two bits sets totaling up to four bits, with each bit set for recording the buffer status of the corresponding isochronous device. Host 30 polls the interrupt device 413 to receive the buffer status, and adjusts the host clock rate at which the sets of data packets are being output.

Although the buffer status in the embodiment is realized using two bits representation to indicate whether the buffer (within the isochronous device, ex. 411) is at a high level or a low level with reference to the middle threshold count, the same effects can be achieved employing other methods, providing that the other methods are within the scope of the claims as being the invention. For instance, the buffer status can be represented with 5 bits rather than 2 bits.

In the embodiment of the invention, the data is preferably output from the host 30 to the isochronous electronic apparatus 40 via a universal serial bus interface, and the data transmission within the isochronous electronic apparatus 40 between the data rate controller 400 and the function device 420 is via an I2S interface.

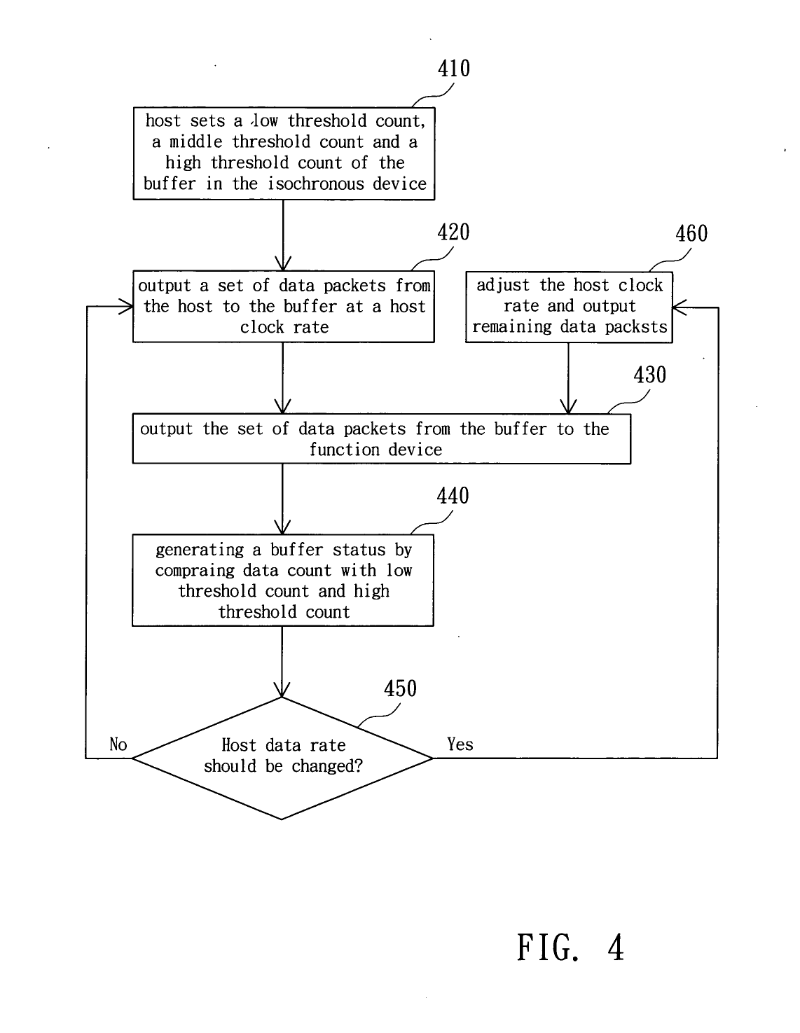

FIG.4 shows illustration of a method of controlling data transmission from a host to a function device via a buffer according to a preferred embodiment of the invention. The method begins at step 410, in which the host sets a low threshold count, a middle threshold count, and a high threshold count of the buffer in the isochronous device. The threshold counts serve as an important indicator of capacity of the buffer. Then, step 420 is performed in which a set of data packets is outputted from the host to the buffer at a host clock rate, such as under a USB protocol. Then, step 430 is performed to output the set of data packets from the buffer to the function device, such as under an I2S protocol. The buffer outputs the data packets to the function device until the buffer is empty. Next, step 440 is performed to monitor a data count of the buffer. The data count records the number of data packets presently buffered. Then, in response to the data count, a buffer status is generated, where the buffer status is at a high level, or a low level.

In step 440, the data count is compared with the high threshold count and the low threshold count, such that the buffer status is at the high level when the data count is higher than or equal to the high threshold count, and the buffer status is at the low level when the data count is lower than or equal to the low threshold count. Following step 440, step 450 is performed for the host to receive the buffer status by polling to determine whether to increase, decrease or maintain the host clock rate. If the host clock rate does not need to be changed, i.e. the buffer status is neither at the high level or low level, then step 420 is returned to resume outputting more data packets at the host clock rate. If the host clock rate does need to be changed, i.e. the buffer status is at the high level or at the low level, being that the either high bit or the low bit is asserted, then step 460 is performed to adjust the host clock rate accordingly.

In the preferred embodiment of the invention, adjusting the host clock rate can be achieved in step 460 by increasing the host clock rate if the buffer status is at the low level, and decreasing the host clock rate if the buffer status is at the high level.

The low and high threshold counts can be configured with reference to the medium threshold count, such as by setting the low threshold count to equal to the medium threshold count minus an integer multiple of a subframe size of the set of data packets, and setting the high threshold count to equal the medium threshold count plus the integer multiple of the subframe size of the set of data packets.

Since the data packets contain a number of subframes, and a certain number of subframes constitute a frame, the preferred embodiment of the invention proposes updating the buffer status in response to a start-of-frame signal, taken in part for realizing the method of controlling data transmission.

In addition, to achieve the method of controlling data transmission from a host to a function device via a buffer, step 460 can be achieved by decreasing the host clock rate by a multiple of a subframe size of the set of data packets if the buffer status is at the high level, or increasing the host clock rate by a multiple of a subframe size of the set of data packets if the buffer status is at the low level.

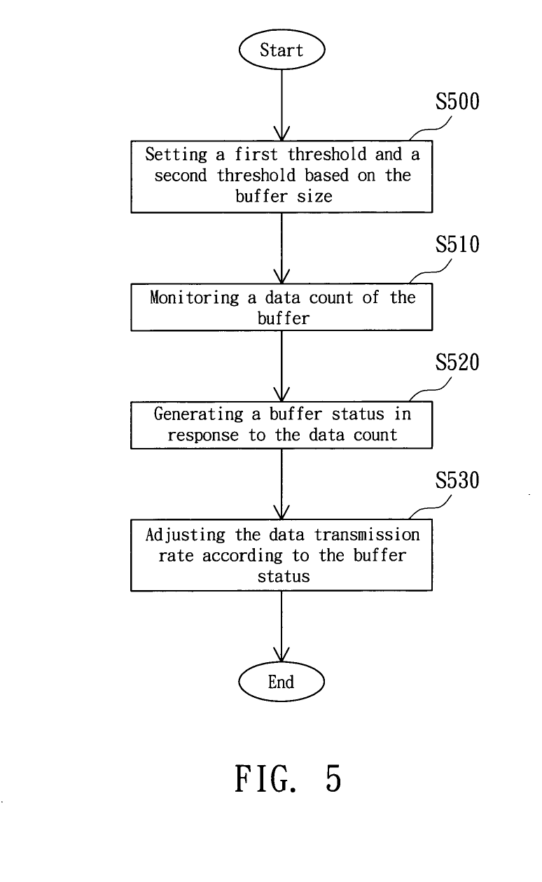

Referring to FIG. 5, it is a flowchart according to another embodiment of this invention, comprising the steps of:

S500: setting a first threshold and a second threshold base on the buffer size.

S510: monitoring a data count of the buffer.

S520: generating a buffer status in response to the data count.

S530: adjusting the data transmission rate according to the buffer status.

In S500, the first threshold is lower than the second threshold based on the buffer size, for example, the first threshold is ⅓ buffer size and the second threshold is ⅔ buffer size.

In S520, generating the buffer status by comparing the data count with these two thresholds, i.e. the first threshold and the second threshold. Moreover, the buffer status indicates a low level when the data count is lower than or equal to the first threshold and the buffer status indicates a high level when the data count is higher than or equal to the second threshold.

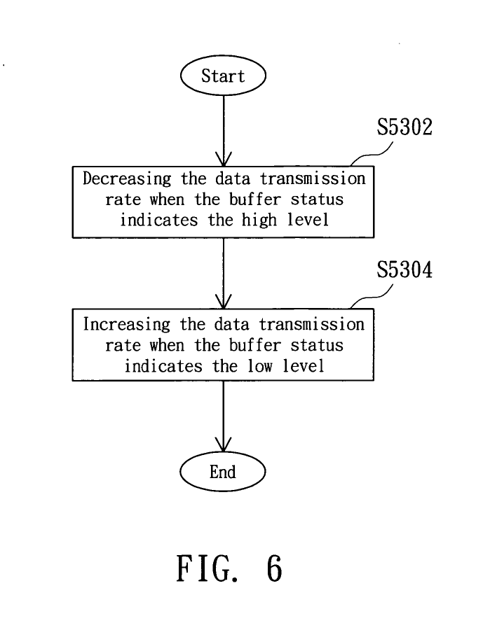

Referring to FIG. 6, it is a flowchart of S530 shown in FIG. 5. The adjusting step S530 further comprises:

S5302: decreasing the data transmission rate when the buffer status indicates the high level.

S5304: increasing the data transmission rate when the buffer status indicates the low level.

In S5302, the buffer status indicates the high level means the data transmission rate is too high and the buffer will be full. In S5304, the buffer status indicates the low level means the data transmission rate is too low to meet process efficiency.

Thus, as shown in the preferred embodiments of the invention, by providing a feedback of the buffer status to the host, the proposed isochronous electronic apparatus, and the method of controlling data transmission, can effectively control the rate at which data packets are being output from the host to the isochronous electronic apparatus, thus effectively preventing conventional problems that result from buffer overrun or under run, and improving the data transmission process that is critical in isochronous transfer applications.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data rate controller, for controlling data transmission between a host and a function device, the host outputting a set of data packets to the data rate controller at a data rate, the data rate controller comprising:
at least one isochronous device, the isochronous device comprising:
a buffer, temporarily storing the set of data packets outputted from the host for outputting the set of data packets to the function device; and
a buffer monitor, coupling to the buffer, for recording a data count while the set of data packets is being output from the host to the buffer, and generating a buffer status; and
an interrupt device, for outputting the buffer status received from the buffer monitor.

2. The data rate controller according to claim 1, wherein the buffer status comprises a bit set having a high bit, and a low bit, wherein the buffer monitor asserts the high bit when the data count is higher than or equal to a high threshold count, and asserts the low bit when the data count is lower than or equal to a low threshold count.

3. The data rate controller according to claim 2, wherein the low threshold count and the high threshold count are set by the host in response to a buffer size of the buffer and the data rate, before the set of data packets is being output from the host.

4. The data rate controller according to claim 2, wherein the interrupt device comprises a register for latching the high bit and the low bit.

5. The date rate controller according to claim 2, wherein the host decreases the host clock rate if the high bit is asserted, and increases the host clock rate if the low bit is asserted.

6. The data rate controller according to claim 1, wherein the buffer is a first-in-first-out (FIFO) buffer.

7. The data rate controller according to claim 2, wherein the buffer monitor updates the buffer status in response to a start-of-frame (SOF) signal.

8. The data rate controller according to claim 1 further comprising a synchronous circuit for receiving the set of data packets from the buffer and outputting the set of data packets to the function device.

9. The data rate controller according to claim 1, wherein the set of data packets is output from the host to the data rate controller via a universal serial bus interface.

10. The data rate controller according to claim 1, wherein the set of data packets is output from the data rate controller to the function device via an I2S interface.

11. A method of controlling data transmission from a host to a function device via a buffer, comprising:
outputting a set of data packets from the host to the buffer at a host clock rate;
outputting the set of data packets from the buffer to the function device;
monitoring a data count of the buffer;
generating a buffer status in response to the data count, wherein the buffer status is at a high level, or a low level;
polling the buffer status for receiving the same; and
adjusting the host clock rate according to the buffer status.

12. The method according to claim 11 further comprising setting a high threshold count and a low threshold count according to the host clock rate and a buffer size of the buffer.

13. The method according to claim 12, wherein the step of generating the buffer status comprises comparing the data count respectively with the high threshold count and the low threshold count such that the buffer status is at the high level when the data count is higher than the high threshold count, and the buffer status is at the low level when the data count is lower than the low threshold count.

14. The method according to claim 11 further comprises updating the buffer status in response to a start-of-frame signal.

15. The method according to claim 11, wherein the step of adjusting comprises:
increasing the host clock rate if the buffer status is at the low level; and
decreasing the host clock rate if the buffer status is at the high level.

16. The method according to claim 11, wherein outputting the set of data packets from the host based on a USB protocol.

17. The method according to claim 11, wherein outputting the set of data packets from the buffer based on an I2S protocol.

18. The method according to claim 11 further comprises setting the middle threshold count according to the host clock rate and a buffer size of the buffer.

19. The method according to claim 18, wherein the generating step further comprises setting the low threshold count to equal to the middle threshold count minus a multiple of a subframe size of the set of data packets, and setting the high threshold count to equal the middle threshold count plus the multiple of the subframe size of the set of data packets.

20. The method according to claim 15, wherein the step of adjusting further comprises decreasing the host clock rate by a multiple of a subframe size of the set of data packets if the buffer status is at the high level, and increasing the host clock rate by the multiple of the subframe size of the set of data packets if the buffer status is at the low level.

21. A method for controlling a data transmission rate from a host to a buffer, comprising:
setting a first threshold and a second threshold based on the size of the buffer;
monitoring a data count of the buffer;
generating a buffer status in response to the data count; and
adjusting the data transmission rate according to the buffer status.

22. The method according to claim 21, wherein the buffer status indicates a low level when the data count is lower than or equal to the first threshold, or a high level when the data count is higher than or equal to the second threshold, wherein the first threshold is lower than the second threshold.

23. The method according to claim 22 further comprising decreasing the data transmission rate when the buffer status indicates the high level, and increasing the data transmission rate when the buffer status indicates the low level.

24. The method according to claim 21, wherein data transmission from the host to the buffer is based on USB protocol.

25. The method according to claim 21, the generating step acts in response to a start-of-frame (SOF) signal.
